(19) United States
(12) Patent Application Publication
(10) Pub. No.: US 2025/0226428 A1
(43) Pub. Date: Jul. 10, 2025

(54) METHOD FOR OPERATING A FUEL CELL SYSTEM

(71) Applicant: Robert Bosch GmbH, Stuttgart (DE)

(72) Inventor: Helerson Kemmer, Vaihingen (DE)

(21) Appl. No.: 18/853,487

(22) PCT Filed: Mar. 31, 2023
(86) PCT No.: PCT/EP2023/058494

§ 371 Date: Oct. 2, 2024

(30) Foreign Application Priority Data
Apr. 7, 2022 (DE) 10 2022 203 514.3

(51) Int. Cl. H01M 8/04746; H01M 8/04302; H01M 8/04303; H01M 8/0444; H01M 8/04537; H01M 8/04791; H01M 8/18

(52) U.S. Cl. CPC H01M 8/04761; H01M 8/04447; H01M 8/04559; H01M 8/04805; H01M 8/18; H01M 8/04302; H01M 8/04303

(57) ABSTRACT

The invention relates to a method for operating a fuel cell system (1) comprising at least one fuel cell stack (100) having a cathode (110) and an anode (120), wherein, during normal operation of the fuel cell system (1), the cathode (110) is supplied with air via a supply air path (111), and exhaust air exiting the fuel cell stack (100) is discharged via an exhaust air path (112), and wherein the anode (120) is supplied with hydrogen via an anode circuit (121). If poisoning of an anode catalyst of the fuel cell stack (100) is identified, regeneration of the anode catalyst is initiated, wherein exhaust air is diverted out of the exhaust path (112) or an exhaust path (212) of a further fuel cell stack (200) and is introduced into the anode circuit (121) of the anode (120).

### BACKGROUND

The invention relates to a method for operating a fuel cell system.

Preferred areas of application are fuel cell vehicles, preferably fuel cell vehicles with start-stop operation.

Fuel cells are electrochemical energy converters. In particular, hydrogen (H₂) and oxygen (O₂) can be used as reaction gases. These are converted into electrical energy, water (H₂O), and heat with the aid of a fuel cell. The core of a fuel cell is a membrane electrode assembly (MEA), which comprises a membrane coated on both sides with a catalytic material to form electrodes. During operation of the fuel cell, one electrode, the anode, is supplied with hydrogen and the other electrode, the cathode, is supplied with oxygen.

### SUMMARY

In practice, a large number of fuel cells are connected to form a fuel cell stack in order to increase the electrical output. In addition, multiple fuel cell stacks or fuel cell systems can be interconnected.

The hydrogen supplied to the fuel cell must be very pure to avoid damaging the fuel cell or components or surfaces in the fuel cell system. Depending on the manner in which the hydrogen is produced, it may contain residues of other gases, e.g. CO or the like, that may poison the anode catalyst.

Many poisoning events can be reversed by supplying oxygen to the anode of the fuel cell stack, which results in oxidation of the poisoned areas (“recovery”).

During normal operation of a fuel cell system, no oxygen is supplied to the anode of a fuel cell stack. When shutting down or stopping the fuel cell stack, steps are also taken to prevent oxygen from entering the anode circuit or the anode to prevent degradation of the fuel cells.

The present invention is concerned with the object of inducing oxidation in the poisoned sites when poisoning of the anode catalyst is established or suspected. The service life of the fuel cell stack and the anode components is intended to be increased in this manner.

The method according to the disclosure is proposed in order to achieve this object. Advantageous embodiments of the invention can be gathered from the dependent claims.

Proposed is method for operating a fuel cell system having at least one fuel cell stack comprising a cathode and an anode. During normal operation of the fuel cell system, air is supplied to the cathode via a supply air path and exhaust air exiting the fuel cell stack is discharged via an exhaust air path. The anode is supplied with hydrogen via an anode circuit. According to the invention, if poisoning of an anode catalyst of the fuel cell stack is identified, a recovery function for regenerating the anode catalyst is initiated. Exhaust air is diverted from the exhaust path or an exhaust path of a further fuel cell stack and is introduced into the anode circuit of the anode.

Since the exhaust gas from a fuel cell stack generally has a very low oxygen concentration, it can be introduced to the anode circuit and used to regenerate the anode catalyst. Poisoning of the anode catalyst can thus be easily counteracted. If the fuel cell system comprises only one fuel cell stack, only one exhaust air path is available from which the exhaust air required for regeneration of the anode catalyst can be diverted. If the fuel cell system comprises multiple fuel cell stacks, the exhaust air from a further fuel cell stack can also be used to regenerate the anode catalyst.

Regeneration of the anode catalyst increases the service life of the fuel cell stack, in particular the electrochemical layers made of catalytic material. This is true because, among other things, the migration of metal ions into the membrane is reduced.

Poisoning of the anode catalyst can be advantageously identified when a reduction between the expected voltage at the fuel cell stack for a certain current and the actual measured voltage at the fuel cell stack is established. The SoH (State of Health) of the cells is determined on an ongoing basis for this purpose and compared with reference values.

Poisoning of the anode catalyst can be easily identified when a gas sensor is arranged in the anode circuit, and said sensor measures a critical amount of an interfering gas (contamination amount), e.g. CO, having been exceeded. The poisoning is identified after a critical threshold of the accumulated amounts of contamination is identified.

Poisoning of the anode catalyst can also be identified when a critical amount of the interfering gases totaled over a certain period of time that were incorporated during fueling and registered due to the quality of the hydrogen is exceeded. Since a communication interface is established between the gas station and the vehicle every time the vehicle is fueled, this data regarding the quality of the hydrogen can be transmitted to the vehicle and logged there. Poisoning of the anode catalyst is identified after a critical threshold of accumulated amounts of contaminants is exceeded. Feedback regarding the poisoning of other vehicles also fueled at this gas station can also be used for this purpose (swarm intelligence). The cloud function can also provide warnings regarding the gas station or hydrogen quality to the driver prior to fueling.

If the required exhaust air is diverted from the exhaust air path of the same fuel cell stack, it is preferably introduced via a purge valve and/or drain valve, which is integrated into the anode circuit and is connected to the exhaust air path of the same fuel cell stack via a connecting line. Since a purge valve and/or drain valve is or are regularly present, which are also regularly connected to the exhaust air path via a connection line, existing components can be used to perform the method. In this case, the method is completely system-neutral, as no additional components are required. Since the connection line is usually used to introduce a purge volume discharged via the purge valve and/or drain valve into the exhaust air path in order to dilute it, only the flow direction in the connection line needs to be temporarily reversed.

To reverse the direction of flow, it is proposed that the supply pressure in the exhaust air path be temporarily increased relative to the pressure in the anode circuit, for example by 20 mbar. Due to the pressure difference, exhaust air then flows from the exhaust air path into the anode circuit when the purge and/or drain valve is open.

If the required exhaust air is diverted from the exhaust air path of a further fuel cell stack, it is preferably introduced to the anode circuit of the first fuel cell stack via a separate connecting line comprising an integrated shutoff valve. In other words, at least one additional connecting line and one additional valve are provided to connect the anode circuit of a first fuel cell stack to the exhaust air path of a further fuel cell stack. The separate connection line has the advantage that there is no need for a temporary increase in pressure in the exhaust air path compared to the pressure in the anode circuit of the same fuel cell stack. Since the pressure differences in the cell membranes can also change with the pressure increase, which can lead to fatigue and failure of the membrane material in the long term, using the exhaust air from a further fuel cell stack is an improvement over using the cell's own exhaust air.

If the fuel cell system comprises multiple fuel cell stacks, each anode circuit of a fuel cell stack can be connected to the exhaust air path of a further fuel cell stack via a separate connecting line comprising an integrated shutoff valve. In this way, the anode surfaces of all fuel cell stacks can be passivated or repassivated periodically using the exhaust air from the other fuel cell stack. The number of additional connection lines and valves then preferably corresponds to the number of fuel cell stacks.

It is further proposed that, in a fuel cell system comprising multiple fuel cell stacks, the overall pressure level of the additional fuel cell stack is temporarily raised relative to that of the first fuel cell stack. In contrast to the previously described increase in pressure in the exhaust air path compared to the pressure in the anode circuit of the same fuel cell stack, the pressures on the cathode side and the anode side always remain coupled to each other, so that damaging pressure differences cannot occur in the cell membranes. Temporarily raising the overall pressure level of the additional fuel cell stack ensures that exhaust air flows from its exhaust air path into the anode circuit of the connected fuel cell stack when the shutoff valve integrated into the connecting line is opened.

Furthermore, preferably the oxygen concentration of the exhaust air in the exhaust air path is temporarily decreased to regenerate the anode catalyst. This applies in each case to the exhaust air path from which the exhaust air required for regeneration is diverted, regardless of whether it is the exhaust air path of the same or a further fuel cell stack. The effectiveness of the method can be further increased by reducing the oxygen concentration.

Reducing the oxygen concentration can be achieved in various ways, for example by reducing the air stoichiometry, by increasing the flow without adjusting the air supply, and/or by increasing the exhaust air recirculation rate.

As an additional measure, it is proposed that a fan integrated into the anode circuit be operated while the exhaust air is being fed into the anode circuit. The fan can be used to intensify the circulation of the exhaust air introduced into the anode circuit so that it is better distributed throughout the anode circuit. In particular, the fan can be a recirculation fan, which is used to recirculate anode gas exiting the fuel cell stack in the anode circuit during normal operation of the system.

In addition, a fuel cell system comprising multiple fuel cell stacks is proposed to achieve the object specified hereinabove. The fuel cell stacks of the fuel cell system each have a cathode and an anode, whereby the cathodes are each connected to a supply air path on the inlet side and to an exhaust air path on the outlet side. The anodes are each connected to an anode circuit. According to the invention, the exhaust air path of at least one fuel cell stack can be connected to the anode circuit of a further fuel cell stack via a separate connecting line comprising an integrated shutoff valve.

The proposed fuel cell system is therefore suitable for performing the method or can be operated according to the method, so that the same advantages can be achieved. In particular, the anode surfaces of at least one fuel cell stack can be passivated or repassivated using the exhaust air from a further fuel cell stack. As a result, the service life of the fuel cell stack is increased.

Ideally, each fuel cell stack of the fuel cell system has an anode circuit that is connected to an exhaust air path of a further fuel cell stack via a separate connecting line comprising an integrated shutoff valve in order to be able to passivate or repassivate the anode surfaces with the aid of the exhaust air from the other fuel cell stack. The service life of all fuel cell stacks can be increased accordingly.

### BRIEF DESCRIPTION OF THE DRAWINGS

A preferred embodiment of the invention is explained in more detail below with reference to the accompanying drawings. Shown are:

FIG. 1 a schematic representation of a fuel cell system,

FIG. 2 the sequence of a method according to the invention, according to which the fuel cell system in FIG. 1 can be operated,

FIG. 3 a schematic representation of a further fuel cell system according to the invention, and

FIG. 4 the sequence of a method according to the invention, according to which the fuel cell system in FIG. 3 can be operated.

### DETAILED DESCRIPTION

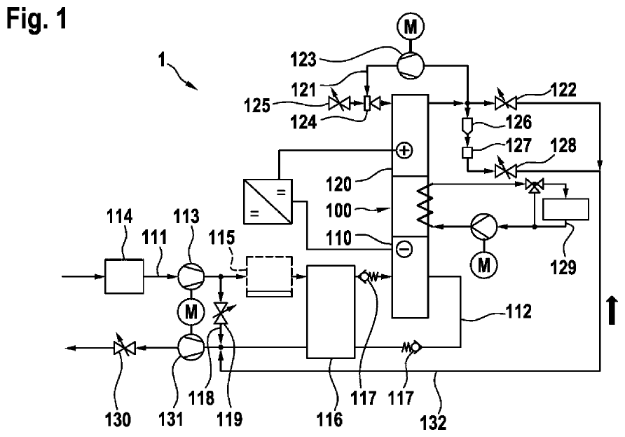

FIG. 1 shows a first fuel cell system 1 which is suitable for performing a method according to the invention or can be operated according to such a method. The fuel cell system 1 in FIG. 1 comprises a fuel cell stack 100 having a cathode 110 and an anode 120. The cathode 110 is supplied with air as an oxygen supplier via a supply air path 111. The air is taken from the surroundings and first supplied to an air filter 114. It is then compressed by means of an air conveying and air compression system 113. Since the air heats up during compression, it is cooled by means of of a heat exchanger 115 that is integrated into the supply air path 111 and optionally humidified by means of a humidifier 116 that is also integrated into the supply air path 111. However, the heat exchanger 115 and/or the humidifier 116 are not absolutely necessary. On the outlet side, the fuel cell stack 100 is connected to an exhaust air path 112, which leads through the humidifier 116, so that the humid exhaust air can be used to humidify the supply air. Downstream of the humidifier 116, the exhaust air is supplied to a turbine 131 of the air conveying and air compression system 113, with the aid of which some of the energy previously used for compression can be recovered. The exhaust air is discharged from the exhaust air path 112 via a pressure control valve 130 arranged downstream of the turbine 131. A bypass path 118 and a bypass valve 119 are provided to bypass the fuel cell stack 100. The supply air path 111 can be connected to the exhaust air path 112 via the bypass path 118 and the bypass valve 119. To prevent the air from flowing back, a check valve 117 can be integrated into both the supply air path 111 and the exhaust air path 112.

The anode 120 of the fuel cell stack 100 is supplied with an anode gas via an anode circuit 121. This can be hydrogen in particular. Since the anode gas exiting the fuel cell stack 100 generally still contains hydrogen, the anode gas is recirculated via the anode circuit 121, i.e. passively with the aid of a jet pump 124 and actively with the aid of a fan 123. Since recirculated anode gas is enriched with nitrogen over time, the anode circuit 121 is purged periodically. For this purpose, a purge valve 122 is integrated into the anode circuit 121 and connected to the exhaust air path 112 via a connecting line 132, so that the purge volume can be introduced into the exhaust air path 112. In the exhaust air path 112, the purge volume, which may still contain hydrogen, mixes with the exhaust air so that a dilution is achieved that prevents an explosive gas mixture from forming. Water produced during operation of the fuel cell stack 100 can be separated by means of a water separator 126 integrated into the anode circuit 121 and collected in a container 127. The container 127 can be emptied as required by opening a drain valve 128. Emptying takes place in the connection line 132, as anode gas can also escape with the water. The heat that is also generated during operation is dissipated with the aid of a cooling circuit 129.

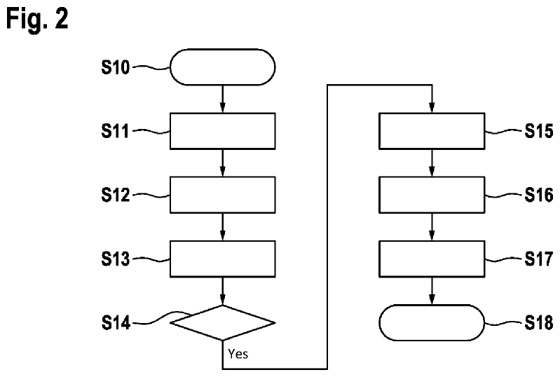

The fuel cell system 1 shown in FIG. 1 can be operated according to the method shown in FIG. 2, which is described below

In step S10, the regeneration of the anode catalyst of the fuel cell stack 100 is initiated. In the subsequent step S11, the pressure in the exhaust air path 112, namely upstream of the turbine 131, is raised slightly relative to the pressure in the anode circuit 121, so that a pressure difference of, e.g., 20 mbar is achieved. In step S12, which is optional, the oxygen concentration of the exhaust air in the exhaust air path 112 is reduced. Subsequently, in step S13, the purge valve 122 and/or the drain valve 128 is/are opened. Due to the pressure difference between the pressure in the exhaust air path 112 and the pressure in the anode circuit 121, exhaust air then flows in the opposite direction of flow (see arrow in FIG. 1) from the exhaust air path 112 via the connecting line 132 into the anode circuit 121. In step S14, it is checked whether a certain regeneration time, e.g. 2 seconds, has been achieved. If the result of the test is positive (“yes”), the purge valve 122 and/or the drain valve 128 can be closed again in step S15. Also in step S16, the oxygen concentration in the exhaust air path 112 can be raised to a normal level again, provided that step S12 has been performed. In step S17, the previously adjusted pressure difference between the pressure in the exhaust air path 112 and the pressure in the anode circuit 121 is also relieved. The method is then ended in step S18.

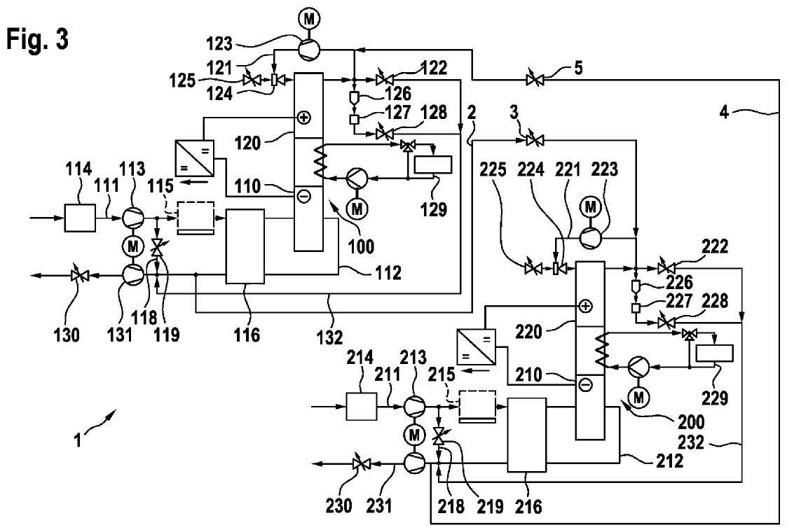

One embodiment of the invention can be achieved by means of a fuel cell system 1 comprising a plurality of fuel cell stacks 100, 200. An example of such a fuel cell system 1 is shown in FIG. 3.

FIG. 3 shows a fuel cell system 1 according to the invention comprising a first fuel cell stack 100 and a second fuel cell stack 200. The fuel cell stacks 100, 200 each have a cathode 110, 210 and an anode 120, 220. The cathodes 110, 210 are each supplied with air as an oxygen supplier via a supply air path 111, 211. The air is taken from the surroundings and supplied via an air filter 114, 214 to an air conveying and air compression system 113 in order 213 to provide a certain air mass flow and a certain pressure level. Since the air heats up in the process, it can be cooled with the aid of a heat exchanger 115, 215 integrated into the supply air path 111, 211 and humidified with the aid of a humidifier 116, 216. The exhaust air from the fuel cell stacks 100, 200 is discharged via an exhaust air path 112, 212. A turbine 131, 231 for energy recovery and a pressure control valve 130, 230 are integrated into the exhaust air path 112, 212. To bypass the fuel cell stacks 100, 200, the supply air paths 111, 211 and the exhaust air paths 112, 212 can each be connected via a bypass path 118, 218 comprising an integrated bypass valve 119, 219.

The anodes 120, 220 of the two fuel cell stacks 100, 200 are each supplied with fresh anode gas or hydrogen and with recirculated anode gas via an anode circuit 121, 221. Recirculation is achieved passively with the aid of a jet pump 124, 224 and actively with the aid of a fan 123, 223. Since the recirculated anode gas is enriched with nitrogen over time, which diffuses from the cathode side to the anode side, a purge valve 122, 222 is provided in each of the anode circuits 121, 221. By opening the purge valve 122, 222, nitrogen-containing anode gas is discharged from the anode circuit 121, 221 and introduced via a connecting line 132, 232 into the respective exhaust air path 112, 212 for dilution. Since the recirculated anode gas is also enriched with water, a water separator 126, 226 comprising a container 127, 227 is also integrated into each of the anode circuits 121, 221. The container 127, 227 can be emptied periodically by opening a respective drain valve 128, 228.

The heat generated during operation of the fuel cell stacks 100, 200 is dissipated by means of a cooling circuit 129, 229.

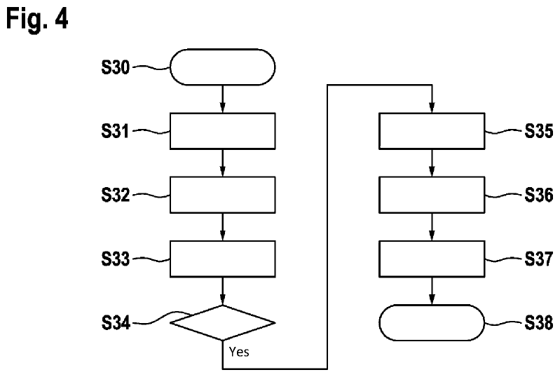

The anode circuits 121, 221 of the two fuel cell stacks 100, 200 are each connected or connectable to the exhaust air path 212, 112 of the respective other fuel cell stack 200, 100 via a separate connecting line 2, 4 comprising the integrated shutoff valve 3, 5. To regenerate the anode catalyst, the shutoff valves 3, 5 can then be opened in sequence, and the exhaust air from the exhaust air path 112, 212 of one fuel cell stack 100, 200 can be introduced into the anode circuit 221, 121 of the other fuel cell stack 200, 100 via the respective connecting line 2, 4. In detail, the steps of the method shown in FIG. 4, which is described below, can be performed.

In step S30, the regeneration of the anode catalyst of the anode 220 of the fuel cell stack 200 is initiated. For this purpose, in step S31, the total pressure level in the fuel cell stack 100 is first raised above the total pressure level in the fuel cell stack 200, so that the pressure in the exhaust air path 112 upstream of the turbine 131 is above the pressure in the anode circuit 221 of the fuel cell stack 200. In an optional step S32, the oxygen concentration of the exhaust air in the exhaust air path 112 can also be reduced. The shutoff valve 3 is then opened in step S33, so that exhaust air from the exhaust air path 112 flows into the anode circuit 221 of the fuel cell stack 200 via the connecting line 2 due to the pressure difference. In step S34, it is then checked whether a certain regeneration time, e.g. 2 seconds, has been achieved. If the result of the test is positive (“yes”), the shutoff valve 3 can be closed again in step 35. If step S32 has been performed, the oxygen concentration of the exhaust air in the exhaust air path 112 can be reset to a normal level in an optional step S36. In step S37, the overall pressure level in the fuel cell stack 100 is returned to a normal level so that the method can be terminated in step S38.

In a corresponding manner, the anode catalyst of the anode 120 of the first fuel cell stack 100 can be regenerated via the connecting line 4 and the shutoff valve 5.

1. A method for operating a fuel cell system (1) comprising at least one fuel cell stack (100) having a cathode (110) and an anode (120), wherein, during normal operation of the fuel cell system (1), the cathode (110) is supplied with air via a supply air path (111), and exhaust air exiting the fuel cell stack (100) is discharged via an exhaust air path (112), and wherein the anode (120) is supplied with hydrogen via an anode circuit (121),
wherein, if poisoning of an anode catalyst of the fuel cell stack (100) is identified, regeneration of the anode catalyst is initiated, wherein exhaust air is diverted out of the exhaust path (112) or an exhaust path (212) of a further fuel cell stack (200) and is introduced into the anode circuit (121) of the anode (120).

2. The method according to claim 1,
wherein poisoning of the anode catalyst is identified when a reduction between the voltage expected for a certain current and the actual measured voltage is established.

3. The method according to claim 1,
wherein poisoning of the anode catalyst is identified when it is measured by means of a gas sensor arranged in the anode circuit that a critical amount of an interfering gas has been exceeded.

4. The method according to claim 1,
wherein poisoning of the anode catalyst is identified when a critical amount of interfering gases totaled over a certain period of time that were incorporated during fueling and registered due to the quality of the hydrogen is exceeded.

5. The method according to claim 1,
wherein the diverted exhaust air is introduced via a purge valve (122) and/or drain valve (128), which is integrated into the anode circuit (121) and is connected to the exhaust air path (112) of the same fuel cell stack (100) via a connecting line (130).

6. The method according to claim 1,
wherein the pressure in the exhaust air path (112) is temporarily raised relative to the pressure in the anode circuit (121) by 20 mbar.

7. The method according to claim 1,
wherein the exhaust air diverted from the exhaust air path (212) of a further fuel cell stack (200) is introduced into the anode circuit (121) of the first fuel cell stack (100) via a separate connecting line (2) comprising an integrated shutoff valve (3).

8. The method according to claim 7,
wherein the overall pressure level of the further fuel cell stack (200) is temporarily raised relative to that of the first fuel cell stack (100).

9. The method according to claim 1,
wherein the oxygen concentration of the exhaust air in the exhaust air path (112, 212) is temporarily reduced.

10. The method according to claim 1,
wherein a fan (123) integrated into the anode circuit (121) is operated during the introduction of the exhaust air into the anode circuit (121).
